(19) United States
(12) Patent Application Publication
(10) Pub. No.: US 2020/0086998 A1
(43) Pub. Date: Mar. 19, 2020

(54) TWO-TURBINE ENVIRONMENTAL CONTROL SYSTEM

(71) Applicant: Hamilton Sundstrand Corporation, Charlotte, NC (US)

(72) Inventors: Alan Retersdorf, Avon, CT (US); Matthew Pess, Hartford, CT (US); Gregory L. DeFrancesco, Simsbury, CT (US)

(21) Appl. No.: 16/130,389

(22) Filed: Sep. 13, 2018

(51) Int. Cl. B64D 13/08; F02C 6/08

(52) U.S. Cl. CPC B64D 13/08; B64D 2013/0618; F02C 6/08

(57) ABSTRACT

An environmental control system for an aircraft according to an example of the present disclosure includes a first turbine coupled to an engine and a second turbine coupled to a compressor. One or more ducts are configured to provide bleed air from the engine to the first and second turbines and the compressor such that the first and second turbines and the compressor condition the bleed air. A method of conditioning air is also disclosed.

### STATEMENT REGARDING FEDERALLY SPONSORED RESEARCH OR DEVELOPMENT

This invention was made with Government support under D6004-F3359-3359-2410001 awarded by the United States Air Force. The Government has certain rights in this invention.

### BACKGROUND

Various parts of an aircraft utilize conditioned air for cooling, providing a desired pressure, or other purposes. For instance, conditioned air can be used to provide a comfortable pressurized environment for an aircraft cabin/cockpit. Conditioned air can also be used to cool various parts of the aircraft engine or avionics. Other example uses for conditioned air are smoke detection, fire suppression, or other functions.

An air cycle Environmental Control System (ECS) conditions bleed air from an engine for use in other parts of the aircraft as discussed above. The engine bleed air is typically hot and/or includes moisture. Therefore, the ECS conditions the air by reducing its temperature and/or moisture content for the desired application. Accordingly, an ECS may include one or more heat exchangers and/or condensers to provide cool, dry conditioned air. An ECS may take advantage of ram (outside) air for providing cooling via the heat exchangers.

### SUMMARY

An environmental control system for an aircraft according to an example of the present disclosure includes a first turbine coupled to an engine and a second turbine coupled to a compressor. One or more ducts are configured to provide bleed air from the engine to the first and second turbines and the compressor such that the first and second turbines and the compressor condition the bleed air.

In a further embodiment according to any of the foregoing embodiments, the first turbine is coupled to the engine via an engine gearbox.

In a further embodiment according to any of the foregoing embodiments, a pre-cooler is configured to pre-cool the bleed air prior to it being provided to the first and second turbines and the compressor.

In a further embodiment according to any of the foregoing embodiments, one or more ducts comprise a first duct configured to provide bleed air to the compressor and the second turbine and a second duct is configured to provide bleed air from the compressor and the second turbine to the first turbine.

In a further embodiment according to any of the foregoing embodiments, one or more ducts comprise a first duct configured to provide bleed air to the first turbine and a second duct is configured to provide bleed air from the first turbine to the compressor and the second turbine.

In a further embodiment according to any of the foregoing embodiments, one or more heat exchangers and one or more water collectors are configured to condition the bleed air.

In a further embodiment according to any of the foregoing embodiments, at least one of the one or more heat exchangers is in communication with at least one of cooling liquid and fuel from the engine.

In a further embodiment according to any of the foregoing embodiments, the conditioning includes at least one of cooling and drying the bleed air.

In a further embodiment according to any of the foregoing embodiments, the first and second turbines, the compressor, and the engine are all situated in a common compartment of an aircraft.

In a further embodiment according to any of the foregoing embodiments, the first turbine is situated in an engine compartment of an aircraft, and the second turbine and the compressor are situated in another compartment separate from the engine compartment.

In a further embodiment according to any of the foregoing embodiments, the engine is a two-spool turbofan, and the bleed air is from a compressor section of the two-spool turbofan.

A method of conditioning air according to an example of the present disclosure includes providing bleed air from an engine to an environmental control system. The environmental control system includes a first turbine coupled to an engine, and a second turbine coupled to a compressor. The bleed air is conditioned by the first and second turbines and the compressor.

In a further embodiment according to any of the foregoing embodiments, the method of conditioning air provides the bleed air to a pre-cooler prior to providing the bleed air to the first and second turbines and the compressor.

In a further embodiment according to any of the foregoing embodiments, the method of conditioning air provides bleed air to the compressor and second turbine prior to providing bleed air to the first turbine.

In a further embodiment according to any of the foregoing embodiments, the method of conditioning air includes providing bleed air to the first turbine prior to providing bleed air to the compressor and the second turbine.

In a further embodiment according to any of the foregoing embodiments, the method of conditioning air includes providing conditioned air to at least one of an aircraft cabin, an aircraft cockpit, an aircraft On Board Inert Gas Generator System (OBIGGS), or aircraft avionics.

In a further embodiment according to any of the foregoing embodiments, the method of conditioning air includes at least one of cooling and drying.

### BRIEF DESCRIPTION OF THE DRAWINGS

FIG. 1 schematically shows an engine and Environmental Control

System.

FIG. 2 schematically shows an example pneumatic arrangement for the Environmental Control System of FIG. 1.

FIG. 3 schematically shows another example pneumatic arrangement for the Environmental Control System of FIG. 1.

### DETAILED DESCRIPTION

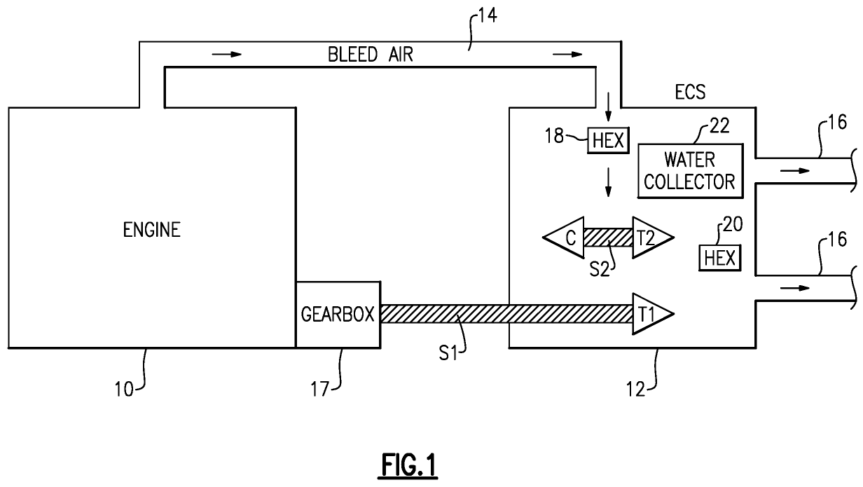

FIG. 1 schematically shows an engine 10 and an Environmental Control System (ECS) 12. The engine 10 is a gas turbine engine for an aircraft. One example gas turbine engine is a two-spool turbofan that generally incorporates a fan section, a compressor section, a combustor section, and a turbine section. The fan section drives air along a bypass flow path and also along a core engine flow path. Air in the core engine flow path is compressed in the compression section and then communication to a combustor in the combustor section for combustion, followed by expansion in the turbine section. Other example engines have single-spool or three-spool architectures, or other arrangements.

The ECS 12 receives bleed air from the engine 10 via bleed air line 14. The bleed air line 14 can draw bleed air from various stages of the engine 10, depending on the engine 10 architecture and design as discussed above. In the two-spool engine example, bleed air can be drawn from the compressor section.

The ECS 12 conditions the bleed air by passing it through turbines and compressors. The turbines and compressors are arranged and operated to provide maximum cooling efficiency. The ECS 12 may also include one or more heat exchangers 20 and/or water collectors 22 to provide additional cooling and drying for the bleed air. The ECS 12 may also include various valves and sensors for controlling airflow and temperature. The conditioned bleed air is then sent to various parts of the aircraft via ducts 16. For example, conditioned bleed air can be used to provide a comfortable pressurized environment for an aircraft cabin/cockpit, for engine or avionics cooling, for an On Board Inert Gas Generating System (OBIGGS), or other applications.

In one example, the ECS cooling system can interact with other cooling systems of the aircraft, such as fuel or liquid cooling systems. That is, some of the heat exchangers 20 in the ECS can be in communication with liquid or fuel from the engine 10 to provide cooling.

With continued reference to FIG. 1, the ECS 12 is powered by a two-stage turbine air cycle system to maximize the refrigeration (cooling) of the ECS. A first turbine T1 is coupled directly to the engine 10 by shaft S1 via an engine gearbox 17. That is, power is transmitted between the first turbine T1 and the engine 10 via the gearbox 17. The second turbine T2 is coupled to a compressor C as a “bootstrap” air cycle machine (ACM) via shaft S2. A pre-cooler 18 pre-cools the bleed air before it is provided to the first and second turbines T1, T2 and compressor C. As the air passes through the first turbine T1 and the ACM comprising the second turbine T2 and compressor C, it is cooled.

The turbines T1, T2 reduce ECS 12 overall power consumption and increases overall ECS 12 efficiency. In turn, the overall power consumption of the engine 10 is reduced and the overall efficiency of the engine 10 is increased. The first turbine T1 allows power from the ECS 12 to be recycled to the engine 10 via the gearbox 17. Since the first turbine T1 shares power with the engine 10 via the gearbox 17, it has a lower heat rejection requirement (e.g., amount of heat removed, which directly correlates to a power requirement for the turbine) than a turbine in a bootstrap cycle like the turbine T2. On the other hand, since the first turbine T1 is coupled to the engine 10, its location within the ECS 12 and its speed control is more limited as compared to the second turbine T2. However, since the second turbine T2 is only coupled to the compressor C, there is more flexibility in its location within the ECS 12 as well as increased control of its speed and operation as compared to the first turbine T1. For instance, the second turbine T2 may be located in a compartment separate from the engine 10 compartment. Accordingly, the two turbines T1 and T2 together provide an overall reduced heat rejection requirement while maintaining adequate flexibility in installation and control for the ECS 12.

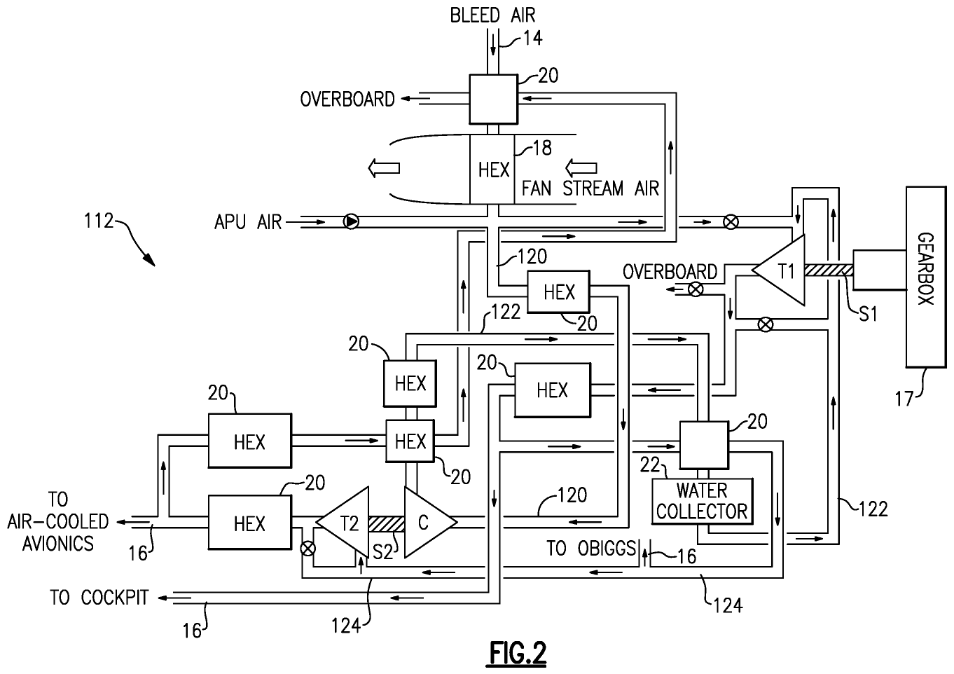

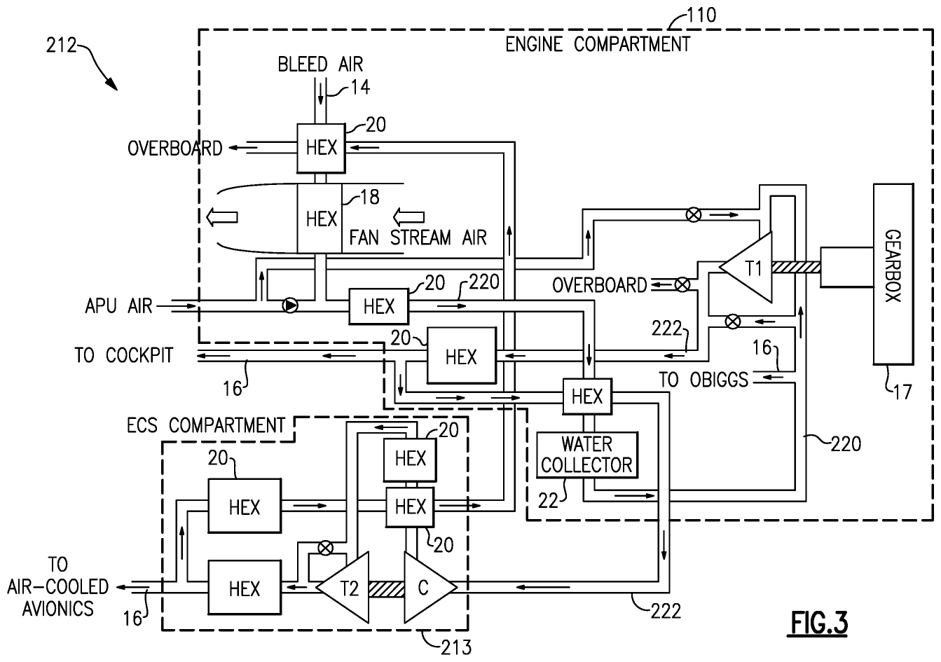

FIGS. 2 and 3 show two example pneumatic arrangements for the ECS 12. Turning first to FIG. 2, the example ECS 112 routes bleed air from the bleed air duct 14 through the pre-cooler 18. The pre-cooler 18 is a heat exchanger which in this example, is cooled by air from the engine 10 fan. In another example, the pre-cooler 18 may be cooled by ram (outside) air. Bleed air is then routed via duct 120 to the compressor C and the second turbine T2. Then, bleed air is routed via duct 122 to the first turbine T1. Air is recycled from the first turbine T1 back through the second turbine T2 via duct 124.

In this example, the first and second turbines T1 and T2 and the compressor C are all situated adjacent the engine 10 (not shown). In a more particular example, the first and second turbines T1 and T2 and the compressor C are all situated in a common compartment with the engine 10. However, it should be understood that in other examples the second turbine T2 and the compressor C can be situated in a separate compartment from the engine and first turbine T1.

As shown in the example of FIG. 2, the ECS 112 includes various heat exchangers 20 and a water collector 22. As the bleed air is routed through the compressor C, second turbine T2, and first turbine T1, it passes through the heat exchangers 20 and water collected 22 and is cooled and dried. As discussed above the heat exchangers 20 can interact with other cooling systems of the engine 10, such as fuel or liquid cooling systems. Though the example ECS 112 includes a certain number and arrangement of heat exchangers 20 and water collectors 22, it should be understood any number or arrangement of heat exchangers 20 and water collectors 22 are contemplated by this arrangement.

The ECS 112 conditions (e.g., cools and dries) the bleed air as discussed above and provides it to various engine locations via ducts 16, such as air-cooled avionics, OBIGGS, and the aircraft cockpit, though ducts 16 can provide air to other locations as well, as discussed above.

Turning now to FIG. 3, another example ECS 212 is shown. In this example, the first turbine T1 is situated in an engine compartment 110, while the second turbine T2 and compressor C are situated in a separate ECS compartment 213. However, it should be understood that in other examples, the first and second turbines T1 and T2 and the compressor C can all be situated in a common compartment with the engine 10. In ECS 212, bleed air from the bleed air duct 14 is routed through the pre-cooler 18. As above, the pre-cooler 18 is a heat exchanger which in this example, is cooled by air from the engine 10 fan. In another example, the pre-cooler 18 may be cooled by ram (outside) air. Bleed air is then routed via duct 220 to the first turbine T1. Then, bleed air is routed via duct 222 to the compressor C and second turbine T2.

As shown in the example of FIG. 2, the ECS 212 includes various heat exchangers 20 and a water collector 22. As the bleed air is routed through the first turbine T1, compressor C, and second turbine T2, it passes through the heat exchangers 20 and water collected 22 and is cooled and dried. As discussed above the heat exchangers 20 can interact with other cooling systems of the engine 10, such as fuel or liquid cooling systems. Though the example ECS 212 includes a certain number and arrangement of heat exchangers 20 and water collectors 22, it should be understood any number or arrangement of heat exchangers 20 and water collectors 22 are contemplated by this arrangement.

The ECS 212 conditions (e.g., cools and dries) the bleed air as discussed above and provides it to various engine locations via ducts 16, such as air-cooled avionics, OBIGGS, and the aircraft cockpit, though ducts 16 can provide air to other locations as well, as discussed above.

Though the ECS 112 and the ECS 212 in the examples of FIGS. 2 and 3, respectively, have different pneumatic arrangements (that is, air is routed differently in the ECS 112 and the ECS 212), they both have first turbine T1 and second turbine T2 which provide an overall reduced heat rejection requirement while maintaining adequate the flexibility in installation and control, as discussed above.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An environmental control system for an aircraft, comprising:
a first turbine coupled to an engine;
a second turbine coupled to a compressor; and
one or more ducts configured to provide bleed air from the engine to the first and second turbines and the compressor such that the first and second turbines and the compressor condition the bleed air.

2. The environmental control system of claim 1, wherein the first turbine is coupled to the engine via an engine gearbox.

3. The environmental control system of claim 1, further comprising a pre-cooler configured to pre-cool the bleed air prior to it being provided to the first and second turbines and the compressor.

4. The environmental control system of claim 1, wherein the one or more ducts comprises a first duct configured to provide bleed air to the compressor and the second turbine and a second duct configured to provide bleed air from the compressor and the second turbine to the first turbine.

5. The environmental control system of claim 1, wherein the one or more ducts comprises a first duct configured to provide bleed air to the first turbine and a second duct configured to provide bleed air from the first turbine to the compressor and the second turbine.

6. The environmental control system of claim 1, further comprising one or more heat exchangers and one or more water collectors configured to condition the bleed air.

7. The environmental control system of claim 6, wherein at least one of the one or more heat exchangers is in communication with at least one of cooling liquid and fuel from the engine.

8. The environmental control system of claim 1, wherein the conditioning includes at least one of cooling and drying the bleed air.

9. The environmental control system of claim 1, wherein the first and second turbines, the compressor, and the engine are all situated in a common compartment of an aircraft.

10. The environmental control system of claim 1, wherein the first turbine is situated in an engine compartment of an aircraft, and the second turbine and the compressor are situated in another compartment separate from the engine compartment.

11. The environmental control system of claim 1, wherein the engine is a two-spool turbofan, and the bleed air is from a compressor section of the two-spool turbofan.

12. A method of conditioning air, comprising:
providing bleed air from an engine to an environmental control system, the environmental control system including a first turbine coupled to an engine, and a second turbine coupled to a compressor, whereby the bleed air is conditioned by the first and second turbines and the compressor.

13. The method of claim 12, further comprising providing the bleed air to a pre-cooler prior to providing the bleed air to the first and second turbines and the compressor.

14. The method of claim 12, wherein providing includes providing bleed air to the compressor and second turbine prior to providing bleed air to the first turbine.

15. The method of claim 12, wherein providing includes providing bleed air to the first turbine prior to providing bleed air to the compressor and the second turbine.

16. The method of claim 12, further comprising providing conditioned air to at least one of an aircraft cabin, an aircraft cockpit, an aircraft On Board Inert Gas Generator System (OBIGGS), or aircraft avionics.

17. The method of claim 12, wherein the conditioning including at least one of cooling and drying.
